(19) United States
(12) Patent Application Publication
(10) Pub. No.: US 2026/0071997 A1
(43) Pub. Date: Mar. 12, 2026

(54) EDDY CURRENT PROBE FOR TIGHT RADIUS TUBING

(71) Applicant: Zetec Inc., Snoqualmie, WA (US)

(72) Inventors: Mathew Joel Caldwell, North Bend, WA (US); Stephen Timm, Bellevue, WA (US)

(21) Appl. No.: 19/317,478

(22) Filed: Sep. 3, 2025

Related U.S. Application Data
(60) Provisional application No. 63/693,754, filed on Sep. 12, 2024.

(51) Int. Cl. G01N 27/9013; G01N 27/90

(52) U.S. Cl. CPC G01N 27/902; G01N 27/9006

(57) ABSTRACT

An eddy current probe head includes an eddy current sensor assembly coupled to a flexible shaft. At least one centering assembly is slidingly moveable along the flexible shaft.

### RELATED APPLICATION

This application claims priority under 35 U.S.C. § 119 based on U.S. Provisional Application No. 63/693,754 filed Sep. 12, 2024, the contents of which are hereby incorporated herein by reference in their entirety.

### BACKGROUND

Routine monitoring of the condition of industrial conduit or tubing is critical to safe and efficient operation of many systems. Such conduit or tube inspection is generally conducted with cylindrically shaped eddy current probes that are inserted into a conduit under test. The eddy current probe travels through the conduit/tubes and emits eddy currents onto surfaces of the tubes. The tubes are attached to cabling while monitoring equipment records the eddy current response as the probe travels through the tubes.

Eddy current probes operate by using coils alternating an electromagnet field onto a conduit as it travels within the conduit and receiving electromagnetic returns via the conduit. The electromagnetic field produces eddy currents in the tubes, which can be measured either by a change in impedance of the excitation coil or by separate coils, hall-effect sensors or magneto-resistive sensors. In interacting with the conduit structure, the probe is able to locate defects by recognizing anomalies, such as disbonds, bubbles, cracks, corrosion, delaminations, thickness variation, and the like.

Typical eddy current probes for non-destructive testing of heat exchanger tubing and the like are composed of a probe head supporting a plurality of sensing coils, a flexible plastic conduit with wiring and a connector providing a removable connection to testing equipment. Probe heads often incorporate features to center the coil assembly in the center of the tube under inspection. This centering reduces “lift-off” in which the probe moves away from the tube wall and such centering is important for maintaining good signal quality.

This centering function has been done in the past by machined plastic, metallic, or ceramic parts that incorporate a plurality of flexible fingers extending from the probe that apply an equal circumferential force to the inner wall of the tubing under inspection. Because these parts bear against the tube wall, they are subject to wear as the sensor is moved in and out of hundreds of tubes which may involve thousands of feet of sliding friction wear. These effects can drive the sensor out of its centered position causing lift-off errors. Additionally, if the wear on the feet is even but substantial, the feet may no longer press against the tube wall and the sensor may become loose within the tube, which causes erratic movement and creates data quality issues. Accordingly, after a period of use the probe becomes unreliable and therefore unusable due to the abraded centering feet.

Unfortunately, as tubing to be tested or conduit for accessing such tubing becomes longer or more convoluted, it has become more difficult to push and pull a probe head through the tubing, rendering portions of a tube inaccessible for inspection and/or reducing probe life. For example, bends in tubing that have about an 8″ radius or smaller may prevent an optimal test probe from being pushed through the entire tube. In such circumstances, conventional testing may require that such tubing be tested from both ends, with the tight radius bending portion being tested using a smaller, less sensitive probe. Testing with multiple probes and testing locations is both time consuming and costly.

### BRIEF DESCRIPTION OF THE DRAWINGS

FIG. 1 is a perspective view of an eddy current probe testing arrangement consistent with embodiments described herein;

FIGS. 2A and 2B illustrate side and cross-sectional views, respectively, of an exemplary eddy current probe assembly consistent with embodiments described herein;

FIGS. 2C and 2D are exploded cross-sectional and isometric views, respectively, of the eddy current probe assembly of FIGS. 2A and 2B; and

FIG. 3 is a side view of the eddy current probe assembly of FIGS. 2A-2D in a tightly bent configuration.

### DESCRIPTION OF THE PREFERRED EMBODIMENTS OF THE INVENTION

The following detailed description refers to the accompanying drawings. The same reference numbers in different drawings may identify the same or similar elements. Also, the following detailed description does not limit the invention.

Implementations described herein relate to a non-destructive testing device assembly that includes one or more testing coils for introducing an electromagnetic field into a tubular conduit under test. The non-destructive testing device assembly includes a probe body coupled to one or more centering assemblies (referred to as centering feet or centering beads) and to a distal end of a length of delivery conduit. As described herein, the centering assemblies include one or more resilient portions configured to be radially biased away from the shaft. The resilient portions are configured to engage the internal surface of the conduit under test to keep the probe body centered within the conduit as the probe body travels within the conduit. In addition, the shaft to which the probe body is coupled may include one or more centering beads positioned thereon for maintaining the shaft in a centered position within the conduit under test.

Consistent with implementations described herein, the probe body and centering assemblies may be coupled together via one or more resilient or flexible members, such that bending or curving of the non-destructive testing device assembly during travel through tightly curved or convoluted tubing may be facilitated. In one implementation, the one or more resilient or flexible members may include a pair of springs coupled to distal and proximal ends of the probe body and onto which at least some of the centering assemblies are slidingly mounted.

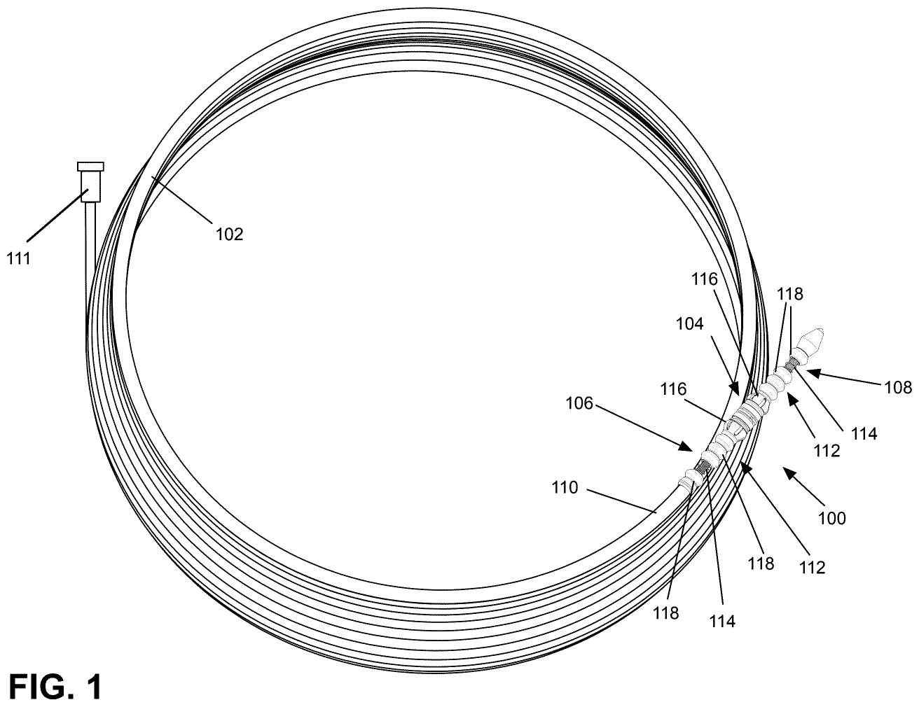

FIG. 1 is an isometric view of an eddy current probe head 100 and delivery tubing 102 consistent with implementations described herein. As shown, eddy current probe head 100 includes a probe body 104, a proximal probe centering apparatus 106 and a distal probe centering apparatus 108. Delivery tubing 102 (also referred to as delivery shaft, or delivery conduit) includes a tubular body 110 coupled to eddy current probe head 100 at its distal end and a probe connector 111 at its proximal end. Delivery tubing 102 is generally configured to be forcibly pushed or withdrawn from a conduit under test by a mechanical or motorized tube or conduit pushing/pulling device.

As shown in FIG. 1, probe body 104 is coupled between proximal probe centering apparatus 106 and distal probe centering apparatus 108. As described herein, centering assemblies 112 are configured to maintain probe body 104 centered within a tube under test during testing. Probe body 104 includes at least one eddy current coil that projects and detects an alternating electromagnetic field within a tube or conduit under test. In some embodiments, as described herein, each of proximal and distal probe centering apparatuses 106/108 includes one or more of centering assemblies 112 for centering probe body 104 within a tube under test (not shown in FIG. 1), even when inserted into tightly bent or convoluted tubing.

Consistent with implementations and as described in additional detail below, each of proximal and distal probe centering apparatuses 106/108 include a flexible central member 114 positioned between the one or more centering assemblies 112, for enabling relative movement between different centering members and between the centering members and the probe body 104.

As further shown in FIG. 1 and consistent with implementations described herein, each of centering assemblies 112 may further include one or more centering feet 116 and centering beads 118. In some implementations, centering feet 116 and centering beads 118 are mounted on resilient central member 114.

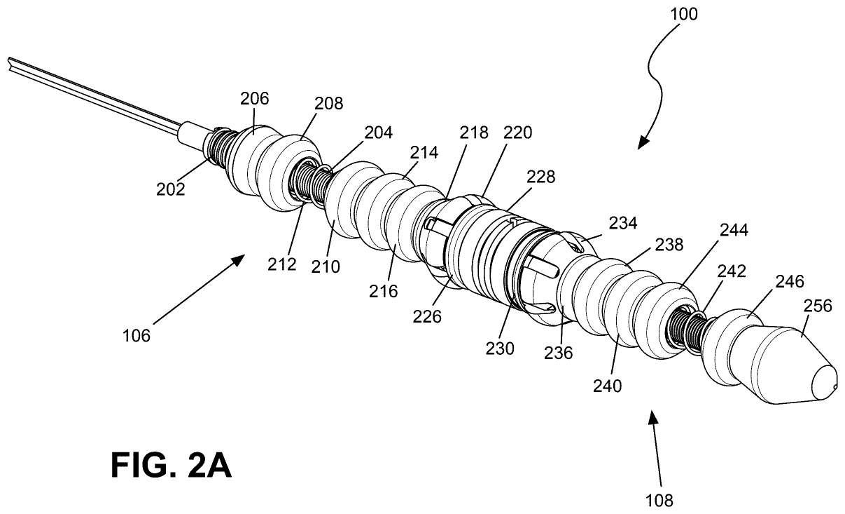

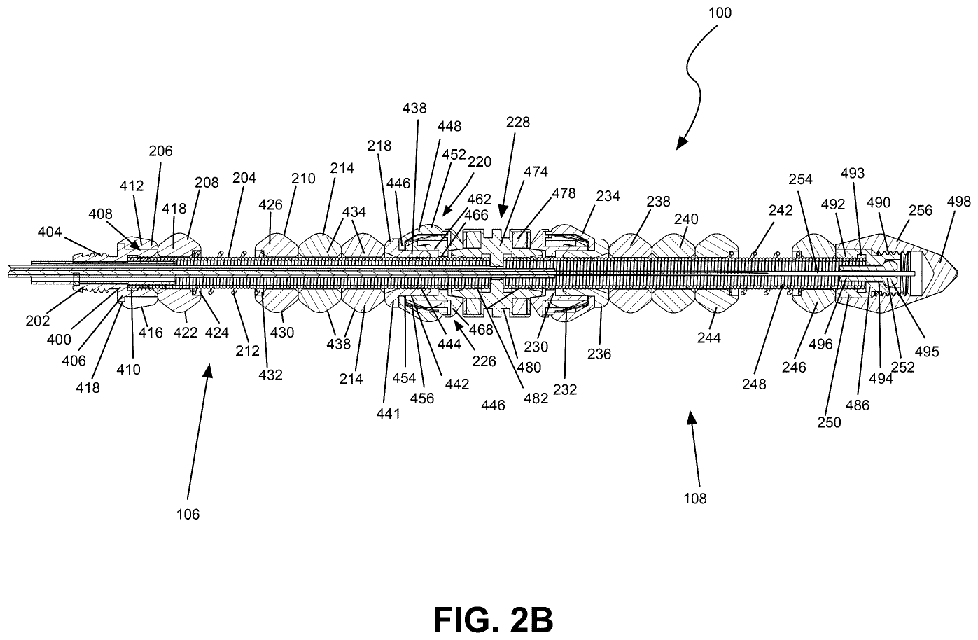

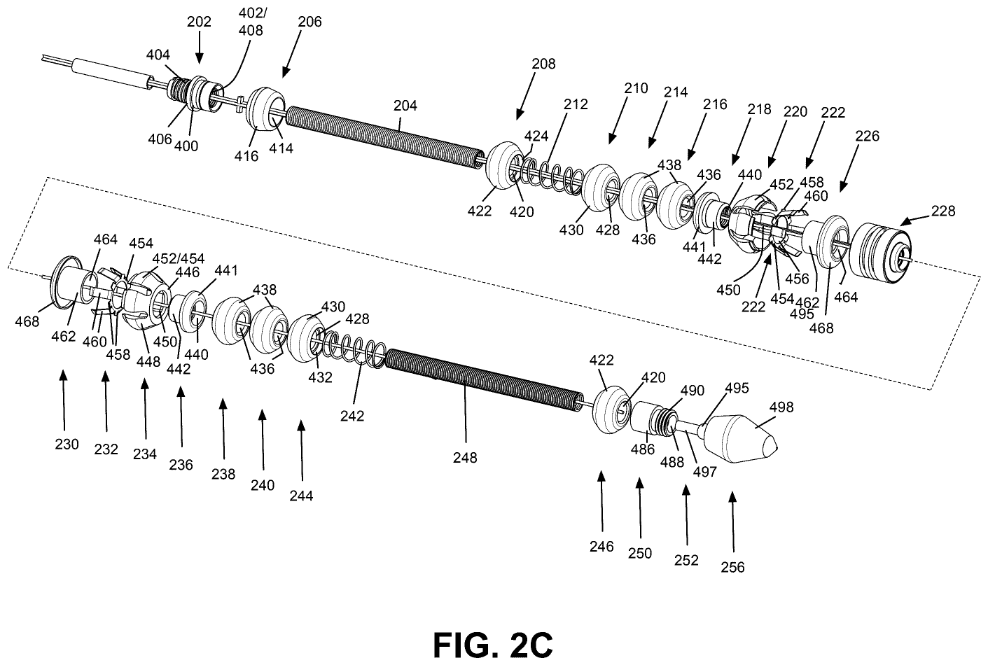

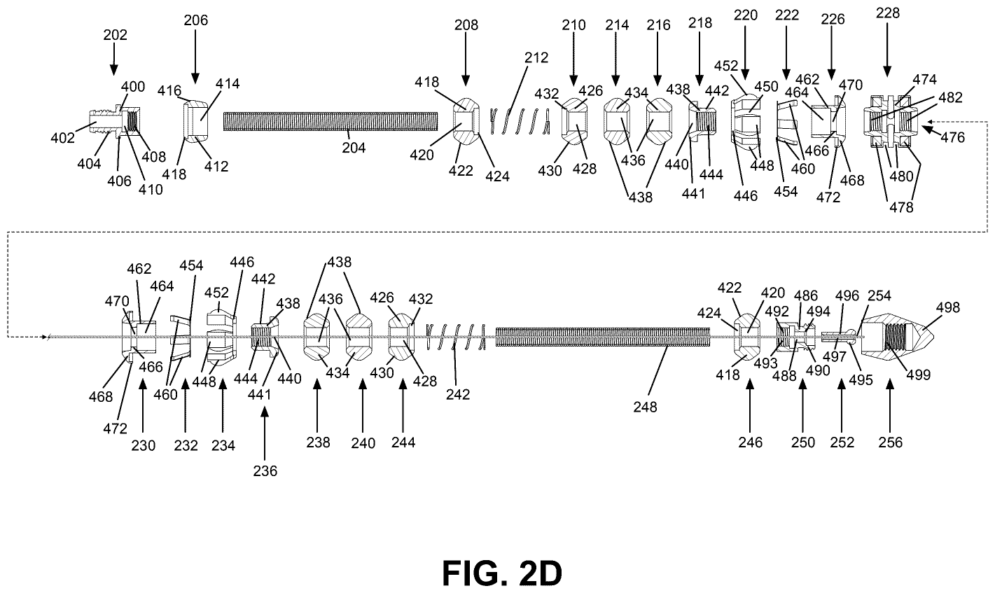

FIGS. 2A and 2B are isometric and side cross-sectional views, respectively, of an eddy current probe head 100 consistent with implementations described herein in an assembled configuration. FIGS. 2C and 2D are isometric and side cross-sectional views, respectively, of eddy current probe head 100 in an exploded configuration. As shown, and as described briefly above, eddy current probe head 100 includes a flexible and resilient structure for accommodating testing of tubes having tight bends or convoluted shapes. In one implementation, eddy current probe head 100 includes probe body 104, distal probe centering apparatus 106 and proximal probe centering apparatus 108, each of which include one or more centering assemblies 112. Consistent with embodiments described herein, probe body 104 includes flexible central member 114 on which or to which each of probe body 104, distal probe centering apparatus 106, and proximal probe centering apparatus 108 are mounted.

As shown in FIGS. 2A-2D, proximal probe centering apparatus 106 includes an adapter member 202, a first flexible member 204, a junction centering bead 206, a first proximal counter-bored centering bead 208, a second proximal counter-bored 210, a proximal biasing spring 212, a first full centering bead 214, a second full centering bead 216, a proximal bearing center cap 218, a proximal centering assembly 220, a proximal centering assembly spring 222, and a proximal centering assembly capture hub 226. As shown, probe body 104 includes a bobbin assembly 228. Distal probe centering apparatus 108 includes several features similar to proximal probe centering apparatus 106, but positioned in reverse order, such as a distal centering assembly capture hub 230, a distal centering assembly spring 232, a distal centering assembly 234, a distal bearing center cap 236, a third and fourth full centering beads 238/240, a distal biasing spring 242, a first distal counter-bored centering bead 244, and a second distal counter-bored centering bead 246, and a second flexible member 248. In addition, probe head 100 includes a pin retaining element 250, a throw pin 252, a cable 254, and a nose cone 256. Collectively, these components provide a probe head assembly that can accommodate testing tubing having tight radius bends and various convolutions, without requiring a sacrifice in terms of sensor resolution.

As shown in FIG. 2C, adapter member 202 includes a generally tubular body 400 having a central aperture 402 therethrough, a delivery tubing engagement portion 404, a shoulder portion 406, and a flexible member engaging portion 408. Central aperture 402 includes an inside diameter sufficient to accommodate necessary wiring and cabling associated with the eddy current probe. Delivery tubing engagement portion 404 is sized to securely, yet releasably, engage an interior surface of delivery tubing 102 upon assembly. For example, delivery tubing engagement portion 404 may include an exterior surface having engagement ribs or barbs thereon for frictionally engaging delivery tubing 102. Shoulder portion 406 includes a larger outside diameter than delivery tubing engagement portion 404 and engages a proximal end of junction centering bead 206 to seat junction centering bead 206 with respect to the distal end of delivery tubing 102. Flexible member engaging portion 408 includes cavity 410 formed concentrically with central aperture 402 and configured to engagingly receive a proximal end of first flexible member 204. In some implementations, first flexible member 204 may include a tightly wound helical spring. In such implementations, cavity 410 may include a threaded interior surface for engaging the coils on first flexible member 204 to secure first flexible member 204 within cavity 410.

First flexible member 204 may include a generally tubular resilient or flexible element configured to flex or bend when probe head 100 is inserted into a conduit or tube under test. As described above, in some implementations first flexible member 204 may include a tightly wound helical spring coupled at its proximal end to adapter member 202 and at its distal end to bobbin assembly 228.

Junction centering bead 206 includes a tubular body 412 having a central aperture 414 extending therethrough and a curvilinear outer surface 416. In some embodiments, curvilinear outer surface 416 may include a maximum outside diameter at a location proximal to its axial midpoint, although other configurations are possible. As shown in FIG. 2C, central aperture 414 is sized to slidingly engage an outer surface of flexible member engaging portion 408 of adapter member 202. As described briefly above, in some implementations, the proximal end of central aperture 414 of junction centering bead 206 may include an annular groove 418 for engaging shoulder portion 406 of adapter member 202 to allow junction centering bead 206 to seat onto adapter member 202 during assembly.

First proximal counter-bored centering bead 208 includes a tubular body 418 having a central aperture 420 extending therethrough and a curvilinear outer surface 422. In some embodiments, curvilinear outer surface 422 of bead 208 may include a maximum outside diameter at its axial midpoint, although other configurations are possible, as shown in the figures. Consistent with implementations described herein, first proximal counter-bored centering bead 208 includes an annular counter-bore 424 at its distal end for engaging a proximal end of proximal biasing spring 212. For example, annular counter-bore 424 may include a diameter approximately equal to an outside diameter of proximal biasing spring 212. As shown in FIG. 2C, central aperture 420 is sized to slidingly receive first flexible member 204 therethrough, such that flexing of first flexible member 204 may cause a position of centering bead 208 to move axially relative to first flexible member 204.

Second proximal counter-bored centering bead 210 includes a tubular body 426 having a central aperture 428 extending therethrough and a curvilinear outer surface 430. In some embodiments, curvilinear outer surface 430 of bead 210 may include a maximum outside diameter at its axial midpoint, as shown in the figures. Consistent with implementations described herein, second proximal counter-bored centering bead 210 includes an annular counter-bore 432 at its proximal end for engaging a distal end of proximal biasing spring 212. That is, annular counter-bore 432 in centering bead 210 faces annular counter-bore 424 in centering bead 208 to capture proximal biasing spring 212 therebetween. As shown in FIG. 2C, central aperture 428 in centering bead 210, similar to central aperture 420 in centering bead 208, is also sized to slidingly receive first flexible member 204 therethrough.

As described herein, proximal biasing spring 212 may be a helical spring having spaced apart coils in a default or relaxed configuration so as to bias centering bead 210 away from centering bead 208. As described below, when first flexible member 204 flexes (e.g., during progression in a bent or convoluted tube), proximal biasing spring 212 may prevent centering bead 210 from moving too closely toward centering bead 208, thus maintaining bobbin assembly 228 approximately centered axially between proximal probe centering apparatus 106 and distal probe centering apparatus 108.

First full centering bead 214 and second full centering bead 216 each include a tubular body 434 having a central aperture 436 extending therethrough and a curvilinear outer surface 438 similar to outer surface of centering beads 208 and 210. As shown in FIG. 2C, central aperture 436 in first and second full centering beads 214/216 is sized to slidingly receive first flexible member 204 therethrough.

Proximal bearing center cap 218 includes a generally tubular body 438 having a central aperture 440 extending therethrough, a shoulder portion 441 for engaging a distal end of centering bead 216, and a centering assembly engagement portion 442 for engaging a proximal end of centering assembly 220. In contrast to apertures in beads 208, 210, 214, and 216, central aperture 440 of proximal bearing center cap 218 may include a flexible member engagement surface 444 configured to engagingly receive a portion of first flexible member 204. For example, flexible member engagement surface 444 may include a threaded configuration for engaging the coils on first flexible member 204 to secure first flexible member 204 within aperture 440.

As shown in FIGS. 2A and 2C, proximal centering assembly 220 includes a disc-shaped base portion 446, from which a plurality of resilient cantilevered legs 448 project radially and distally outwardly therefrom and are coaxially spaced apart from base portion 446. As shown in FIG. 2C, base portion 446 and resilient cantilevered legs 448 form a central aperture 450 configured to engage proximal centering assembly spring 222 and proximal centering assembly capture hub 226, as described more fully below. Consistent with implementations described herein, base portion 446 and resilient cantilevered legs 448 may be manufactured (e.g., injection molded, 3D printed, etc.) from a single material.

Each cantilevered leg 448 includes a centering foot 452 at its distal end that includes a curvilinear outer surface 454, at least a portion of which is configured to extend beyond a body of bobbin assembly 228. Centering feet 452 on respective legs 448 extend outwardly, such that the circumferentially spaced centering feet 452, and not bobbin assembly 228, slidably engages the tube under test. The resilient nature of cantilevered legs 448 allows each leg to flex as necessary to maintain bobbin assembly 228 centered within the tube when the legs 448 engage the inner surface of the tube. In one implementation, proximal centering assembly 220 includes six cantilevered legs 448, although any suitable number of legs may be used, depending on the size of the eddy current probe head 100 and/or the tubing or conduit under test.

Consistent with implementations described herein, proximal centering assembly spring 222 includes a generally disc-shaped base 454 having a central opening 456 configured to accommodate centering assembly engagement portion 442. As shown in FIG. 2C, proximal centering assembly spring 222 includes a plurality of projections 458 that project radially outwardly from base 454 and align with spaces between cantilevered legs 448 in proximal centering assembly 220. Upon assembly, projections 458 fit between cantilevered legs 448 and prevent rotation of proximal centering assembly spring 222 relative to proximal centering assembly 220.

As shown, proximal centering assembly spring 222 further includes a plurality of prongs 460 that project radially outwardly and distally from base 454 and align with cantilevered legs 448. In one implementation, proximal centering assembly spring 222 is formed of a material, such as thin steel, such that prongs 460 are biased outwardly against respective cantilevered legs 448 to continually urge cantilevered legs 448 outwardly against the tube under test.

Proximal centering assembly capture hub 226 includes a generally tubular body 462 having a central aperture 464 therethrough, an annular inner shoulder portion 466, and a capture flange 468. Central aperture 464 is sized to accommodate tubular body 438 of proximal bearing center cap 218. Annular inner shoulder portion 466 projects radially inwardly from tubular body 462 within central aperture 464 and includes a central aperture 470 configured to slidingly receive first flexible member 204 therethrough. Capture flange 468 projects radially outwardly from a distal end of tubular body 462 and in includes an annular sidewall 472 at its periphery.

As shown in FIG. 2C, capture flange 468 and sidewall 472 are configured to receive a terminus of each cantilevered leg 448, so that feet legs 448 do not become inadvertently distended during insertion or travel through a tube under test. In some implementations, a terminus of each leg 448 may include an annular projection which positively engages capture flange 468 and sidewall 472. As shown, a radial dimension of capture flange 468 relative to body 462 is sufficient to allow radial inward flexing of legs 448 toward body 462.

Bobbin assembly 228 (also referred to as an eddy current sensor assembly) includes various elements associated with eddy current testing, such as magnets, coils, and related wiring. Consistent with implementations described herein, bobbin assembly 228 includes a bobbin body 474 that includes a central aperture 476 therethrough, magnet receiving portions 478, and coil receiving portions 480. As shown, central aperture 476 includes several regions, including flexible member engagement portions 482 and wiring passageway (not shown). Flexible member engagement portions 482 are positioned on either side of wiring passageway and are configured to engagingly receive a distal end of first flexible member 204 and a proximal end of second flexible member 248. When first and second flexible members 204/248 are tightly wound helical springs, flexible member engagement portions 482 include a threaded interior surface for engaging the coils on the springs.

As shown in FIGS. 2A-2D, several of the features of distal probe centering apparatus 108 are similar to proximal probe centering apparatus 106, but positioned in reverse order, such as a distal centering assembly capture hub 230, a distal centering assembly spring 232, a distal centering assembly 234, a distal bearing center cap 236, a third and fourth full centering beads 238/240, a distal biasing spring 242, a first distal counter-bored centering bead 244, and a second distal counter-bored centering bead 246, and a second flexible member 248. Accordingly, where practical, these elements have been labeled using common numeration with similar features in proximal probe centering apparatus 106.

In particular, distal centering assembly capture hub 230, similar to proximal centering assembly capture hub 226, also includes tubular body 462, annular inner shoulder portion 466, capture flange 468, and annular sidewall 472. Distal centering assembly spring 232, similar to proximal centering assembly spring 222, includes base 454, projections 458, and prongs 460. Distal centering assembly 234, similar to proximal centering assembly 220, includes base portion 446, cantilevered legs 448, and centering feet 452. Distal bearing center cap 236, similar to proximal bearing center cap 218, includes body 438, shoulder portion 441, and centering assembly engagement portion 442, and flexible member engagement surface 444.

Similar to first and second full centering beads 214 and 216 described above, third and fourth full centering beads 238/240 also include bodies 434 and curvilinear outer surfaces 438. Similar to proximal biasing spring 212, distal biasing spring 242, also includes a helical spring configured to engage first distal counter-bored centering bead 244 and a second distal counter-bored centering bead 246. First distal counter-bored centering bead 244 includes a body 426, an outer surface 430, and an annular counter-bore 432. Second distal counter-bored centering bead 246 includes a body 418, an outer surface 422, and an annular counter-bore 424 that opposes annular counter-bore 432 in first distal counter-bored centering bead 244 to capture distal biasing spring 242 therebetween.

As shown in the figures, eddy current probe head 100 further includes pin retaining element 250, a throw pin 252, and a nose cone 256 at its distal end. In particular, similar to adapter member 202, pin retaining element includes a generally tubular body 486 having a central aperture 488 therethrough, a nose cone engagement portion 490, a flexible member engaging portion 492, and a pin engagement shoulder 494. Central aperture 488 includes an inside diameter sufficient to accommodate throw pin 252, and second flexible member 248 therein. Nose cone tubing engagement portion 490 is formed on an outer distal portion of tubular body 486 and is sized to securely, yet releasably, engage nose cone 256 during assembly. For example, nose cone engagement portion 490 may include a threaded outer surface.

Flexible member engaging portion 492 includes cavity 493 formed concentrically with central aperture 488 and configured to engagingly receive a distal end of second flexible member 248. When second flexible member 248 is a tightly wound helical spring, cavity 493 may include a threaded interior surface for engaging the coils on second flexible member 248 to secure second flexible member 248 within cavity 493.

Pin engagement shoulder 494 projects radially inwardly within aperture 488 and includes an inside diameter smaller than a head 495 of pin 252, yet larger than an outside diameter of a shaft 496 of pin 252. As shown in FIG. 2C, throw pin 252 includes a central aperture 497 therethrough for receiving tension cable 254 therein. In particular, during assembly, cable 254 having a fitting (e.g., a t-bar or the like) coupled at its proximal end, such as to adapter member 202, is extended through probe head 100 and through aperture 297 in throw pin 252. After neutral tension is achieved, a distal end of cable 254 is secured within throw pin 252, such as with solder or epoxy. Nose cone 256 includes a generally tubular body having a closed, cone-shaped distal end 498 and an interior cavity 499 having a surface (e.g., a threaded surface) configured to engage nose cone engagement portion 490. In some implementations, a proximal end of nose cone 256 may abut a distal end of second distal counter-bored centering bead 246, as shown in FIG. 2C.

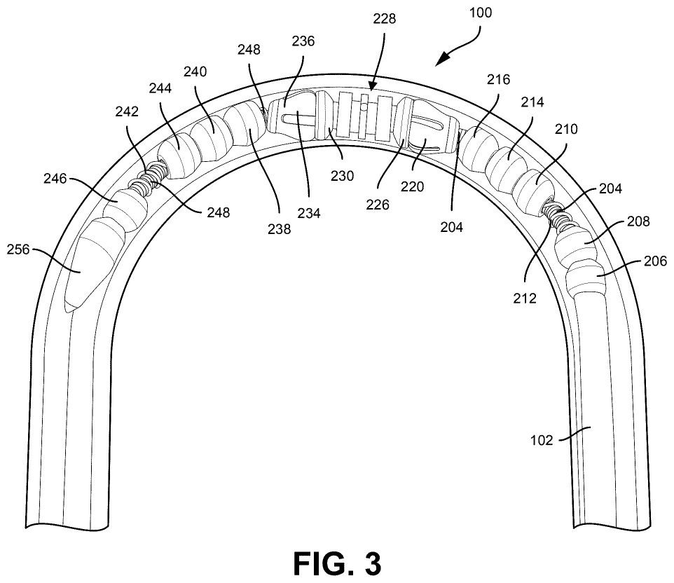

By virtue of the above-described structure features, eddy current probe head 100 may be capable of navigating through tubes having tight bend radii or various convolutions. FIG. 3 is a side view of eddy current probe head 100 and delivery tubing 102 in a tight U-bend configuration. As shown in FIG. 3, the flexible nature of the components of eddy current probe head 100 allows elements to bend relative to each other without binding or inhibiting the centering effect of the components. Accordingly, tight bend radii may be navigated without requiring a smaller size probe head, which necessarily exhibits lower testing resolution and performance.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on”is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

What is claimed is:

1. An eddy current probe head comprising:
an eddy current sensor assembly coupled to a flexible shaft; and
at least one centering assembly slidingly moveable along the flexible shaft.

2. The eddy current probe head of claim 1, wherein the flexible shaft comprises a tightly wound helical spring.

3. The eddy current probe head of claim 1, wherein the wherein the at least one centering assembly comprises at least two centering beads slidingly moveable along the flexible shaft.

4. The eddy current probe head of claim 1, wherein the at least one centering assembly further comprises:
a first centering bead slidingly moveable along the flexible shaft;
a second centering bead slidingly moveable along the flexible shaft; and
a biasing spring positioned between the first centering bead and the second centering bead to bias the first centering bead away from the second centering bead.

5. The eddy current probe head of claim further comprising:
an adapter member fixedly coupled to a proximal end of the flexible shaft,
wherein the first and second centering beads are positioned between the adapter member and the sensor assembly.

6. The eddy current probe head of claim 5, wherein the adapter member is an interface between the eddy current probe head and delivery tubing for inserting the eddy current probe head into a tube under test.

7. The eddy current probe head of claim 1, wherein the at least one centering assembly comprises:
a base portion; and
a plurality of resilient cantilevered legs that project radially and distally outwardly from the base portion,
wherein the base portion is slidingly moveable with respect to the flexible shaft.

8. The eddy current probe head of claim 7, further comprising a centering assembly spring positioned radially inwardly from the plurality of resilient cantilevered legs for biasing the plurality of resilient cantilevered legs away from the flexible shaft.

9. The eddy current probe head of claim 1,
wherein the flexible shaft comprises a first flexible shaft and a second flexible shaft,
wherein the eddy current sensor assembly is coupled between the first flexible shaft and the second flexible shaft, and
wherein the at least one centering assembly comprises:
a first centering assembly slidingly coupled to the first flexible shaft; and
a second centering assembly slidingly coupled to the second flexible shaft.

10. The eddy current probe head of claim 9, wherein each of the first and second centering assemblies comprise at least two centering beads slidingly moveable along the first or second flexible shaft, respectively.

11. The eddy current probe head of claim 10, further comprising:
an adapter member fixedly coupled to a proximal end of the first flexible shaft,
wherein the eddy current sensor assembly is fixedly coupled to a distal end of the first flexible shaft,
a retaining element fixedly coupled to a distal end of the second flexible shaft,
wherein the eddy current sensor assembly is fixedly coupled to a proximal end of the second flexible shaft.

12. The eddy current probe head of claim 11,
wherein the at least two centering beads on the first flexible shaft are positioned between the adapter member and the sensor assembly, and
wherein the at least two centering beads on the second flexible shaft are positioned between the sensor assembly and the retaining element.

13. The eddy current probe head of claim 12, further comprising:
a tension cable fixedly secured between the adapter member and the retaining element.
